(19) United States
(12) Patent Application Publication
(10) Pub. No.: US 2007/0100027 A1
(43) Pub. Date: May 3, 2007

(54) Syntactic polyurethanes and their utilization for off-shore insulation

(75) Inventors: Peter Huntemann, Stemshorn (DE); Udo Schilling, Diepholz (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 10/581,362

(22) PCT Filed: Dec. 9, 2004
(86) PCT No.: PCT/EP04/13990

§ 371 Date: Jun. 2, 2006

(30) Foreign Application Priority Data
Dec. 11, 2003 (DE) 10358368.8

(51) Int. Cl. C08J 9/32

(52) U.S. Cl. 523/218; 523/219

(57) ABSTRACT

Syntactic polyurethanes are obtainable by reacting a polyisocyanate component a) with a polyol component, the polyol component b) comprising a polyetherpolyol based on a difunctional initiator molecule b1), a polyetherpolyol based on a trifunctional initiator molecule b2) and a chain extender b3), in the presence of hollow microspheres c). Furthermore, the syntactic polyurethanes are used for insulating offshore pipes and other parts and equipment used in the offshore sector, and the insulated offshore pipes as such are described.

The present invention relates to a syntactic polyurethane obtainable by reacting a polyisocyanate component a) with a polyol component, the polyol component b) comprising a polyetherpolyol based on a difunctional initiator molecule b1), a polyetherpolyol based on a trifunctional initiator molecule b2) and a chain extender b3), in the presence of hollow microspheres c). The present invention furthermore relates to the use of the syntactic polyurethanes for insulating offshore pipes, and insulated offshore pipes as such, and also other parts and equipment used in the offshore sector.

The term syntactic plastics comprises in general plastics which contain hollow fillers. Syntactic plastics are usually used as thermal insulating coatings, preferably in the offshore sector owing to their advantageous compressive strength and thermal stability. Other known applications are as fireproof material and as sound insulation material.

WO 87/1070 describes a heat insulation material consisting of elastomeric plastic, for example rubber or styrene/butadiene, as a matrix and hollow glass microspheres, the latter being incorporated in an amount of 40-80% by volume.

WO 99/3922, WO 02/72701 and EP-A-896 976 describe syntactic polyurethanes which consist of polyurethane and hollow glass microspheres and are preferably used as an insulating coating for pipes in the offshore sector. Production is effected by adding hollow microspheres to one of the polyurethane system components and then mixing the system components.

In order to obtain good insulation properties of a foam system, it is advantageous to incorporate as many hollow microspheres as possible into the system. What is problematic is that high filler contents lead to system components which have high viscosities and are frequently thixotropic and may be nonpumpable and poorly miscible. These problems are intensified by virtue of the fact that, in the field of use of the polyurethanes, the total filler content usually has to be added to a polyol component since the hollow glass spheres are generally not compatible with the isocyanate because, owing to the water content and/or the alkali metal content at the surface of glass, the quality of the isocyanate is adversely affected.

It is an object of the present invention to provide a formulation for the preparation of syntactic polyurethanes which, on the one hand, permits a high load of hollow microfillers and thus leads to a low overall density and, on the other hand, permits the properties required for offshore insulation, such as good extensibility and a softening point above 150° C. Furthermore, it is also intended to achieve a high level of processing safety.

We have found that this object is achieved by preparing a syntactic polyurethane by reacting commercial polyisocyanates with a special polyol formulation.

The present invention therefore relates to a syntactic polyurethane obtainable by reacting
a) a polyisocyanate component with
b) a polyol component, the polyol component b) comprising the constituents
   b1) a polyetherpolyol based on a difunctional initiator molecule,
   b2) a polyetherpolyol based on a trifunctional initiator molecule and
   b3) a chain extender,
in the presence of
c) hollow microspheres.

In the context of this invention, the term hollow microspheres c) is to be understood as meaning organic and mineral hollow spheres. The organic hollow spheres used may be, for example, hollow plastics spheres, for example comprising polyethylene, polypropylene, polyurethane, polystyrene or a blend thereof. The mineral hollow spheres may contain, for example, clay, aluminum silicate, glass or a mixture thereof.

In the interior, the hollow spheres may have a vacuum or partial vacuum or may be filled with air, inert gases, for example nitrogen, helium or argon, or reactive gases, for example oxygen.

Usually, the organic or mineral hollow spheres have a diameter of from 1 to 1000 μm, preferably from 5 to 200 μm. Usually, the organic or mineral hollow spheres have a bulk density of from 0.1 to 0.4 g/cm³. They generally have a thermal conductivity of from 0.03 to 0.12 W/mK.

Preferably used hollow microspheres are hollow glass microspheres. In a particularly preferred embodiment, the hollow glass microspheres have a hydrostatic compressive strength of at least 20 bar. For example, 3M—Scotchlite® Glass Bubbles may be used as hollow glass microspheres.

The hollow microspheres are generally added in an amount of from 1 to 80, preferably from 2 to 50, more preferably from 5 to 35, particularly preferably from 10 to 30, % by weight, based on the total weight of the resulting syntactic polyurethane.

The following is applicable for the components a) and b):

The polyisocyanates a) used include the conventional aliphatic, cycloaliphatic and in particular aromatic di- and/or polyisocyanates. Toluene diisocyanate (TDI), diphenylmethane diisocyanate (MDI) and in particular mixtures of diphenylmethane diisocyanate and polyphenylenepolymethylene polyisocyanates (crude MDI) are preferably used. The isocyanates may also be modified, for example by incorporating uretdione, carbamate, isocyanurate, carbodiimide, allophanate and in particular urethane groups.

The polyetherpolyols used in the polyol component b) are prepared by processes known from the literature, for example by anionic polymerization with alkali metal hydroxides or alkali metal alcoholates as catalysts or with the aid of double metal cyanide catalysts or with addition of at least one initiator molecule which contains bonded reactive hydrogen atoms, from one or more alkylene oxides having 2 to 4 carbon atoms in the alkylene radical. Suitable alkylene oxides are, for example, tetrahydrofuran, ethylene oxide and 1,2-propylene oxide. The alkylene oxides may be used individually, alternately in succession or as a mixture.

Mixtures of 1,2-propylene oxide and ethylene oxide are preferred, in particular the ethylene oxide being used in amounts of from 10 to 50% as an ethylene oxide end cap (EO cap), so that the resulting polyols have over 70% of primary OH terminal groups. In a further particularly preferred embodiment, only 1,2-propylene oxide is used as the alkylene oxide.

Alcohols, amines or alkanolamines are preferred as the initiator molecule.

It is important with regard to the invention that the polyol component b) comprise the constituents
b1) a polyetherpolyol based on a difunctional initiator molecule,
b2) a polyetherpolyol based on a trifunctional initiator molecule and
b3) a chain extender.

For example, ethanediol, 1,2- and 1,3-propanediol, diethylene glycol, dipropylene glycol, 1,4-butanediol or 1,6-hexanediol or mixtures thereof may be used as difunctional initiator molecules for preparing constituent b1). Diethylene glycol or dipropylene glycol is preferably used.

In general, the alkoxylation of constituent b1) is carried out in a manner such that constituent b1) has a number average molecular weight of from 400 to 3500, preferably from 600 to 2500, particularly preferably from 800 to 1500, g/mol.

Glycerol, trimethylolpropane or a mixture thereof is preferably used as trifunctional initiator molecules for the preparation of the constituent b2).

In general, the alkoxylation of constituent b2) is carried out in a manner such that constituent b2) has a number average molecular weight of from 400 to 8000 g/mol.

In a preferred embodiment, the polyol constituent b2) comprises constituents b2-1) and b2-2), each of these being a polyetherpolyol based on a trifunctional initiator molecule but having different molecular weights.

Constituent b2-1) comprises a polyetherpolyol based in a trifunctional initiator molecule having a number average molecular weight of from 400 to 3500, preferably from 1000 to 3200, particularly preferably from 1500 to 3000, in particular from 1800 to 2900, g/mol.

Constituent b2-2) comprises a polyetherpolyol based on a trifunctional initiator molecule having a number average molecular weight of from more than 3500 to 8000, preferably from 3700 to 7000, particularly preferably from 4000 to 6000, g/mol.

The polyol component b) furthermore contains a chain extender as constituent b3). Chain extenders are generally understood as meaning branched or straight-chain alcohols or amines, preferably dihydric alcohols, having a molecular weight of less than 400, preferably less than 300, in particular from 60 to 250, g/mol. Examples of these are ethylene glycol, 1,4-butanediol, 1,3-propanediol, diethylene glycol or dipropylene glycol. Dipropylene glycol is preferably used.

In a preferred embodiment, the polyol component b) contains, as additional constituent b4), a polyetherpolyol based on an initiator molecule which is tetrafunctional or has a higher functionality. Tetrafunctional to hexafunctional initiator molecules are preferably used. Examples of suitable initiator molecules are pentaerythritol, sorbitol and sucrose.

In a preferred embodiment, the inidividual constituents of the polyol component b) (i.e. constituents b1), b2) (if appropriate in the form of b2-1) and b2-2), b3) and, if appropriate b4)) are chosen so that the polyol component b) has a viscosity of less than 500 mPas at 25° C., preferably of from 200 to 400 mPas at 25° C., measured according to DIN 53019.

In general, the individual constituents of the polyol component b) are used in the following amounts, based in each case on the total weight of the component b):
b1) in an amount of from 20 to 60, preferably from 30 to 50, % by weight,
b2) in an amount of from 20 to 60, preferably from 30 to 50, % by weight and
b3) in an amount of from 5 to 25, preferably from 7 to 20, particularly preferably from 9 to 18, % by weight.

If constituent b2) is divided into constituents b2-1) and b2-2) these are generally used in the following amounts, based in each case on the total weight of the component b):
b1) in an amount of from 5 to 40, preferably from 10 to 30, particularly preferably from 15 to 25, % by weight,
b2) in an amount of from 5 to 40, preferably from 10 to 30, particularly preferably from 15 to 25, % by weight.

If constituent b4) is used, it is generally employed in an amount of from 0.1 to 15, preferably from 1 to 10, particularly preferably from 2 to 7, % by weight.

If required, additives may also be added to the polyol component. Examples of these are catalysts (compounds which accelerate the reaction of the isocyanate component with the polyol component), surface-active substances, dyes, pigments, hydrolysis stabilizers, antioxidants and UV stabilizers.

Furthermore, the polyol component may contain additives imparting thixotropic properties, for example Laromine® C 260 (dimethylmethylenebiscyclohexylamine). In general, the amount of these additives used is from 0.1 to 3 parts by weight, based on 100 parts by weight of the polyol component.

It is furthermore possible to add the blowing agents known from the prior art to the polyol component b). However, it is preferable if the isocyanate component and the polyol component contain no physical and no chemical blowing agent. It is furthermore preferable if no water is added to the components. Thus, the components a) and b) particularly preferably contain no blowing agent, apart from residual water, which is contained in industrially produced polyols.

If is furthermore particularly preferable if the residual water content is reduced by adding water scavengers. Examples of suitable water scavengers are zeolites. The water scavengers are used, for example, in an amount of from 0.1 to 10% by weight, based on the total weight of the polyol component b).

In addition to the novel syntactic polyurethanes, the present invention furthermore relates to a process for the preparation of syntactic polyurethanes by reacting
a) a polyisocyanate component with
b) a polyol component, the polyol component b) comprising the constituents
   b1) a polyetherpolyol based on a difunctional initiator molecule,
   b2) a polyetherpolyol based on a trifunctional initiator molecule and
   b3) a chain extender, in the presence of
c) hollow microspheres.

For the components a) to c) used, reference is made here to the above statements. This also applies to the additives described above.

For the preparation of the polyurethanes, the polyisocyanates a) and polyol component b) are reacted in amounts such that the ratio of the number of equivalents of NCO groups of polyisocyanates a) to the sum of the reactive hydrogen atoms of the component b) is from 1:0.5 to 1:3.50 (corresponding to an isocyanate index of from 50 to 350), preferably from 1:0.85 to 1:1.30, particularly preferably from 1:0.9 to 1:1.15.

The starting components are usually mixed at from 0 to 100° C., preferably from 15 to 60° C., and reacted. The mixing can be effected using the conventional PU processing machines. In a preferred embodiment, the mixing is effected by means of low-pressure machines or high-pressure machines.

The hollow microspheres c) are incorporated into the PU components by methods known from the prior art. It is possible to add the hollow microspheres before the reaction to at least one of the components a) or b) and/or to add the hollow microspheres immediately after reaction of the components a) and b) to the still reacting reaction mixture. Examples of suitable mixing methods are described in WO 94/20286, WO 02/102887 and WO 02/072701. The mixing pot method according to WO 02/102887 is preferably used.

The present invention furthermore relates to the use of the novel syntactic polyurethanes for insulating offshore pipes and for the production of sockets for offshore pipes, and for the production or coating of other parts and equipment in the offshore sector. Examples of other parts and equipment in the offshore sector are borehole connectors, pipe manifolds, pumps and buoys.

In the context of this invention, offshore pipe is understood as meaning a pipe which serves for transporting oil and gas. The oil/gas generally flows therein from the sea bed to platforms, into ships/tankers or directly onto land.

Sockets are to be understood as meaning the joints between two pipes or pipe sections.

The present invention therefore relates to an offshore pipe, composed of
(i) an inner pipe and, adhesively applied thereto,
(ii) a layer of novel syntactic polyurethanes.

In a preferred embodiment, the layer of novel syntactic polyurethanes has a thickness of from 5 to 200 mm, preferably from 10 to 170 mm, particularly preferably from 15 to 150 mm.

It is furthermore possible for a further layer, for example a top layer of a thermoplastic, to be applied to the layer of novel polyurethane. However, it is preferable if no further layer is applied to the layer (ii) of syntactic polyurethane in the novel offshore pipes.

Finally, the present invention relates to a method (also referred to as rotation casting method) for the production of novel offshore pipes, comprising the steps
1) provision of an inner pipe which is to be coated with syntactic polyurethane,
2) axial rotation of the pipe to be coated and
3) application of an unreacted reaction mixture for the production of the layer of syntactic polyurethane, comprising the components a), b) and c), to the rotating pipe.

In general, the application of the reaction mixture is effected in step 3) by pouring onto the rotating pipe. The reaction mixture is a polyurethane mixture which was obtained by mixing the components a), b) and c) by means of conventional mixing apparatuses, for example a low-pressure mixing head. The advance of the mixing head or of the pipe is generally set so that the desired thickness of the syntactic polyurethane layer is achieved with constant output.

1. A syntactic polyurethane prepared by the process of reacting
a) a polyisocyanate component with
b) a polyol component,
the polyol component b) comprising the constituents
b1) a polyetherpolyol based on a difunctional initiator molecule,
b2) a polyetherpolyol based on a trifunctional initiator molecule and
b3) a chain extender, in the presence of
c) hollow microspheres,
the polyol constituent
b2) comprising the constituents
b2-1) a polyetherpolyol based on a trifunctional initiator molecule having an average molecular weight of from 400 to 3500 g/mol and
b2-2) a polyetherpolyol based on a trifunctional initiator molecule having an average molecular weight of from more than 3500 to 8000 g/mol.

2. The syntactic polyurethane according to claim 1, wherein the polyol component b) additionally comprises a constituent
b4) a polyetherpolyol based on an initiator molecule which is tetrafunctional or has a higher functionality.

3. The syntactic polyurethane according to claim 1, wherein the individual constituents of the polyol component b) are selected so that the polyol component b) has a viscosity at 25° C. of less than 500 mPa.s, measured according to DIN 53019.

4. The syntactic polyurethane according to claim 1, wherein the component
b1) is present in an amount of from 20 to 60% by weight, the component
b2) is present in an amount of from 20 to 60% by weight, and the component
b3) is present in an amount of from 5 to 25% by weight,
based on the total weight of the polyol component b).

5. A process for the preparation of syntactic polyurethanes by reacting
a) a polyisocyanate component with
b) a polyol component,
the polyol component b) comprising the constituents
b1) a polyetherpolyol based on a difunctional initiator molecule,
b2) a polyetherpolyol based on a trifunctional initiator molecule and
b3) a chain extender,
in the presence of
c) hollow microspheres,
the polyol constituent b2) comprising the constituents
b2-1) a polyetherpolyol based on a trifunctional initiator molecule having an average molecular weight of from 400 to 3500 g/mol and
b2-2) a polyetherpolyol based on a trifunctional initiator molecule having an average molecular weight of from more than 3500 to 8000 g/mol.

6. The method of using for insulating offshore pipes a syntactic polyurethane prepared by the process of reacting
a) a polyisocyanate component with
b) a polyol component,
the polyol component b) comprising the constituents
b1) a polyetherpolyol based on a difunctional initiator molecule,
b2) a polyetherpolyol based on a trifunctional initiator molecule and
b3) a chain extender,
in the presence of,
c) hollow microspheres.

7. An offshore pipe composed of
(i) an inner pipe and, adhesively applied thereto,
(ii) a layer of a syntactic polyurethane prepared by the process of reacting
a) a polyisocyanate component with
b) a polyol component,
the polyol component b) comprising the constituents
b1) a polyetherpolyol based on a difunctional initiator molecule,
b2) a polyetherpolyol based on a trifunctional initiator molecule and
b3) a chain extender, in the presence of
c) hollow microspheres.

8. The offshore pipe according to claim 7, wherein the layer (ii) of syntactic polyurethane has a thickness of from 5 to 200 mm.

9. A process for the production of offshore pipes according to claim 7, comprising the steps
1) providing an inner pipe which is to be coated with syntactic polyurethane,
2) rotating said pipe to be coated and
3) applying to the rotating pipe an unreacted reaction mixture for the production of the layer of syntactic polyurethane, comprising the components a), b) and c).
